(19) United States
(12) Patent Application Publication
(10) Pub. No.: US 2026/0063690 A1
(43) Pub. Date: Mar. 5, 2026

(54) SYSTEM AND METHOD FOR TRANSFORMING POWER QUALITY AND FAULT RECORDER WAVEFORM MEASUREMENTS INTO SYNCHRO-WAVEFORMS

(71) Applicant: The Regents of the University of California, Oakland, CA (US)

(72) Inventors: Amir-Hamed Mohsenian-Rad, Yorba Linda, CA (US); Zong-Jhen Ye, Santa Clara, CA (US)

(73) Assignee: The Regents of the University of California, Oakland, CA (US)

(21) Appl. No.: 19/313,778

(22) Filed: Aug. 28, 2025

Related U.S. Application Data
(60) Provisional application No. 63/688,569, filed on Aug. 29, 2024.
(60) Provisional application No. 63/709,344, filed on Oct. 18, 2024.

(51) Int. Cl. G01R 22/06; G06F 18/21; G06F 18/22; G06F 123/02

(52) U.S. Cl. CPC G01R 22/063; G06F 18/2193; G06F 18/22; G06F 2123/02

(57) ABSTRACT

A system and method transforms conventional waveform measurements from legacy power quality meters into synchro-waveforms. The system and method does not require legacy power quality meters to be equipped with GPS receivers or other time-synchronization hardware. Data-driven methods operate in two steps: first, they perform optimization-based event signature alignment, and then they use the results to estimate a synchronization operator between any two legacy meters.

### CROSS-REFERENCE TO RELATED APPLICATIONS

This application claims the benefit of the filing date of U.S. Provisional Patent Application No. 63/709,344, filed on Oct. 18, 2024, and U.S. Provisional Patent Application No. 63/688,569, filed on Aug. 29, 2024, each of which is hereby expressly incorporated by reference.

### FIELD OF THE INVENTION

This disclosure relates to the field of signal conversion in particular converting asynchronous signals received from a plurality of sensors to synchronous signals.

### BACKGROUND

Synchro-waveforms, i.e., time-synchronized waveform measurements, have emerged recently as a new measurement technology with diverse applications in power system monitoring and situational awareness. The device to measure synchro-waveforms is often referred to as a Waveform Measurement Unit (WMU). The common approach to achieve time-synchronization among WMUs is to use the Global Positioning System.

WMU installations are still very rare in practice. In fact, although there is already a wide range of sensor technology deployments that do provide voltage and current waveform measurements, such measurements are not time synchronized. One of such conventional technologies that is currently widely used in practice is the power quality sensor. The majority of the existing power quality sensors that have been deployed by many utilities over the past two decades are not equipped with time-synchronization capabilities, such as GPS; due to the high cost. In fact, it was observed in a recent study that the time stamps from conventional power quality sensors can be off by several milliseconds to several seconds.

As a result, while many utilities do have various conventional power quality sensors to measure voltage and current waveforms, they are unable to use such existing measurements as synchro-waveforms due to lack of proper time synchronization. Thus, most utilities are still currently unable to support the emerging applications of synchro-waveforms.

Thus, there is a need for a system and method that solves the shortcomings of prior systems.

### SUMMARY

According to a preferred embodiment of the present invention, through an automated process, waveform measurements are taken from existing conventional power quality meters that are not time-synchronized and the system converts them into synchrowaveforms. The system may be data-driven, working solely by analyzing the event signatures in event-triggered waveform measurements. The first step may include a novel methodologies to align event signatures among unsynchronized sensors. Different optimization-based approaches are developed to achieve computational efficiency and robustness.

The second step estimates the unknown synchronization operators among legacy power quality meters. In this respect, synchronization operators are the offsets in time that are applied to the local clocks at the ordinary power quality meters to time-synchronize their waveform measurements.

According to another preferred embodiment, two approaches are developed to extend the methodology to be applicable to any number of sensors, either with minimum computational burden or with the option to utilize redundancy to enhance performance.

### BRIEF DESCRIPTION OF THE DRAWINGS

FIG. 1 and its subfigures illustrate the moving windows that result in obtaining the time-series of the correlation coefficients according to one embodiment;

FIG. 2 is a figure that illustrates the relationships among synchronization operators according to one embodiment;

FIGS. 3A-3D are a series of graphs that illustrate application of time-synchronized waveform measurements in benchmarking the behavior of DERs on power distribution systems according to one embodiment;

FIG. 4 is a diagram schematically illustrating two time-series (e.g., two signals) comprising the two sets of event signatures captured by the first (top) and second (bottom) power quality sensors according to one embodiment; and

FIG. 5 is a diagram that schematically illustrates three time-series corresponding to waveform measurements captured by three different sensors that are not time synchronized according to one embodiment.

### DETAILED DESCRIPTION

For the purpose of illustrating the invention, there is shown in the accompanying drawings several embodiments of the invention. However, it should be understood by those of ordinary skill in the art that the invention is not limited to the precise arrangements and instrumentalities shown therein and described below.

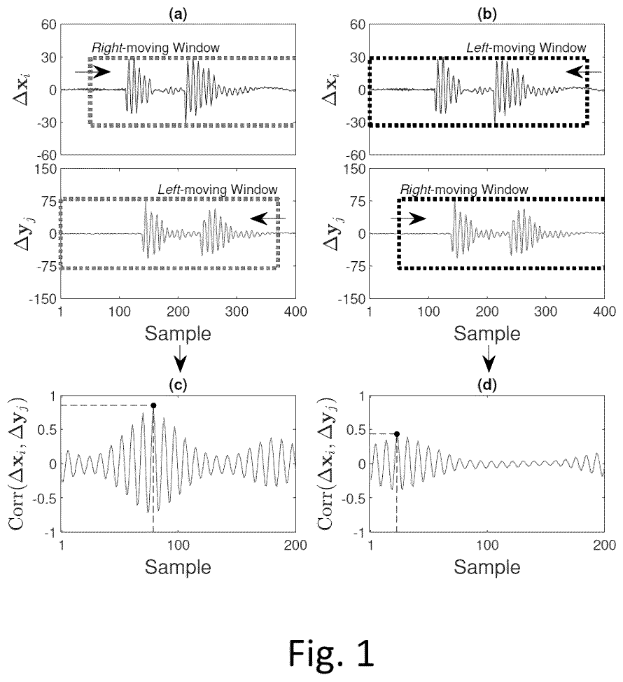

The system and method for converting asynchronous signals received from a plurality of sensors to synchronous signals is disclosed in accordance with preferred embodiments of the present invention is illustrated in FIGS. 1-5, wherein like reference numerals are used throughout to designate like elements.

Synchronized voltage and/or current measurements, also known as synchro-waveforms, received from sensors that monitor power systems, can be used to support various applications in power system monitoring and situational awareness. Some existing systems use GPS (Geographical Positioning Systems) to synchronize (time-synchronize) measurements received from a plurality of sensors (e.g., power quality sensors), having different local clocks. However, a significant portion of existing power quality sensors and fault recorders currently deployed by utility providers and/or power systems (e.g., those installed over the past two decades) are not equipped with synchronization capabilities, to generate synchronized waveforms, e.g., based on GPS signals. In some cases, the high cost associated with GPS-based synchronization may not allow equipping these power quality sensors with synchronization capabilities. In other cases, technical restrictions due, for example, to the position or location of the sensors (e.g., underground or in locations associated with high levels of interference) may prevent the use of GPS-based synchronization. As a result, the time stamps from many existing power quality sensors and fault recorders can be off or differ by some amount of time. For example, the time stamps associated with single event may differ by several microseconds, several milliseconds, or in some cases, several seconds. As such, power systems that are equipped with such power quality sensors for measuring and monitoring voltage and current waveforms may not benefit from emerging applications of synchro-waveforms.

The disclosed systems and methods provide a data-driven method for transforming power quality (PQ) and fault recorder (FR) waveform measurements received from different sensors having independent clocks, into synchro-waveforms (e.g., waveform that are synchronized).

In some embodiments, the disclosed waveform synchronization methods and systems may use data-driven algorithms configured to receive measured data from two or more power quality sensors and generate synchronized waveforms by temporally aligning event signatures without using common clock signal shared between the power quality sensors (e.g., without using a GPS signal).

In various implementations, a power quality sensor may generate a signal comprising a waveform that includes one or more event signatures (e.g., indicated by a deviation of a phase and/or the amplitude of the waveform from expected values associated with established pattern). In some examples, a signal and the corresponding waveform may comprise a time-series comprising a number of sample points collected at a given rate (e.g., at a given number of samples per cycle). An event signature may comprise a portion of the sample points in the time-series. In some examples, the signal (or the waveform) may comprise measured current, measured voltage, measured electric power, or measured value of another parameter indicating performance of a power system. In some examples, a waveform synchronization system may determine a time-shift using two or more signals received from two different sensors and synchronize two signals each received from one of the two different sensors by temporally aligning the two signals using the time-shift (e.g., shifting one signal with respect to the other one by the determined time-shift).

In some embodiments, the disclosed methods may comprise a data-driven event synchronization method that can synchronize event signatures in a plurality of unsynchronized signals received from multiple Waveform Measurement Units (WMUs), e.g., power quality sensors, which may be installed at different locations of a system (e.g., different nodes of a power distribution and management system), by comparing the unsynchronized signals and the corresponding waveforms. In some embodiments, a signal synchronization system may use the data-driven event synchronization method described below to determine time-shifts between a plurality of unsynchronized signals received from different ones of a plurality of sensors and generate synchronized signals (e.g., transform the unsynchronized signals to synchronized signals) by shifting the unsynchronized signals based on respective time-shifts. In various embodiments, the method may be used to synchronize waveforms (e.g., event signatures) generated by an arbitrary number of conventional power quality sensors.

As an example, assuming that the waveform measurements come from two ordinary power quality sensors that are not time-synchronized. The focus is on identifying a subset of the event signatures from the two power quality sensors to pair and align them to help estimate the unknown synchronization operator. There are three different approaches in this section. They are summarized in Table 1.

TABLE I
SUMMARY OF APPROACHES FOR
EVENT SIGNATURE ALIGNMENT

| | Optimization | Finding | Computational | |
|---|---|---|---|---|
| Approach | with Fixed M | M | Efficiency | Robustness |
| 1 | Eq. (19) | Eq. (20) | High | Low |
| 2 | Eq. (22) | Eq. (23) | Low | High |
| 3 | Eq. (19) | Eq. (23) | High | High |

In each approach, it is first assumed that the parameter M=|χ∩ [symbol] , i.e., the total number of the pairs of the event signatures that need to be aligned. This auxiliary assumption is relaxed to also estimate parameter M itself. The goal is to ultimately achieve a methodology that is both computationally efficient and robust (e.g. Approach 3).

### Metric to Compare Event Signatures

Consider two time-series of the waveform measurements that are captured (through event-triggered waveform recording mechanisms) by two unsynchronized power quality sensors.

The time-series of the waveform measurements from the first power quality sensor is denoted by vector x and the time-series of the waveform measurements from the second power quality sensor is denoted by vector y. To derive the differential waveforms corresponding to time-series x and time-series y as follows:

$$Δ x = x [ CT + 1 : n ] - x [ 1 : n - CT ] , \\ Δ y = y [ CT + 1 : n ] - y [ 1 : n - CT ] , \qquad ( 8 )$$

where T is the sampling rate of the power quality sensors, such as T=128 samples per cycle for all the real-world case studies described herein. The differential waveforms in equation (8) are the difference between the original waveform measurements and the delayed versions of the same waveform measurements, where the delay is C cycles. In one embodiment, C=3 cycles is set to assure separating the duplicate event signatures in differential waveforms. Comparing event signatures based on differential waveforms (instead of raw waveforms) has many advantages, such as removing the impact of the background load to focus only on the waveform signature that is caused by the event. Whenever needed, the method can use the per-unit representation of the waveforms before extracting Δx and Δy to have comparable event signatures.

Events in a correct event pair {xi, yj} may show similar patterns between Δxi and Δyj; because they are supposed to be captured during the same physical event in the system.

To quantify the similarity between the event signatures in a pair of differential waveforms in Δxi and Δyj, the following is defined:

$${σ}_{i j}^{RL} = {max}_{k = 1 : ⌊ η / 2 ⌋ - 1} Corr ( Δ {x}_{i} ( k : η ) , Δ {y}_{j} ( 1 : η - k + 1 ) ) , \qquad ( 9 )$$

$$and$$

$${σ}_{i j}^{LR} = {max}_{k = 1 : ⌊ η / 2 ⌋ - 1} Corr ( Δ {x}_{i} ( 1 : η - k + 1 ) , Δ {y}_{j} ( k : η ) ) , \qquad ( 10 )$$

where η=n−CT denotes the length of the time-series of the differential waveforms, and Corr(·,·) denotes the correlation coefficient between the two time-series. In equation (9), compared is a right-moving window in Δxi with a left-moving window in Δyj, as shown in FIG. 1, graph (a). The correlation coefficient is calculated at each step in such comparison; creating the correlation coefficient time-series in FIG. 1, graph (c). The maximum in such correlation coefficient time-series is denoted by σ_{RL}, at the point that is marked with the black dot on this figure.

In FIG. 1 moving windows in graph (a) results in obtaining the time-series of the correlation coefficients in graph (c), based on the formulations in equations (9) and (12). The black circle and its dashed lines indicate the values of σ_{RL ij} and k_{RL ij}. Similarly, the moving windows in graph (b) result in obtaining the time-series of the correlation coefficients in graph (d), based on the formulations in equations (10) and (13). The black circle and its dashed lines indicate the values of σ_{LRij} and k_{LRij}. Accordingly, we can obtain σᵢⱼ and kᵢⱼ based on equations (11) and (14).

In equation (9), we move Δxi along Δyj. In (10), we move Δyj along Δxi. Together, these two comparisons fully examine the similarities between Δxi and Δyj. In practice, a typical power quality meter records the waveform measurements from n/2 samples before the event-trigger point to n/2 samples after the event-trigger point. As a result, the recorded event signature always starts at the midpoint of the time-series of the captured waveform in equation (1). Therefore, we set the range of k in equations (9) and (10) based on η/2 instead of η. This reduces computation time and also ensures that correlation coefficient calculation always includes at least η/2 samples.

The following metric to assess the similarity between the event signature time-series in xᵢ and in yⱼ:

$${σ}_{i j} = max \{ {σ}_{i j}^{RL} , {σ}_{i j}^{LR} \} . \qquad ( 11 )$$

This metric indicates the maximum correlation that can be achieved between xᵢ and yⱼ among all possible alignments between a window with a length of at least η/2 samples. Importantly, the maximization in equation (9) and the maximization in equation (10) can also provide us with the positions (sample numbers) of the moving windows that result in achieving the highest correlation coefficients. In this regard, the following can be obtained:

$${k}_{i j}^{RL} = {arg max}_{k = 1 : ⌊ η / 2 ⌋ - 1} Corr ( Δ {x}_{i} ( k : η ) , Δ {y}_{j} ( 1 : η - k + 1 ) ) , \qquad ( 12 )$$

$$and$$

$${k}_{i j}^{LR} = {arg max}_{k = 1 : ⌊ η / 2 ⌋ - 1} Corr ( Δ {x}_{i} ( 1 : η - k + 1 ) , Δ {y}_{j} ( k : η ) ) . \qquad ( 13 )$$

The values of

$${σ}_{i j}^{RL} and {k}_{i j}^{RL}$$

are marked respectively with the horizontal and the vertical dashed lines in FIG. 1, equation (c). Similarly, the values of

$${σ}_{i j}^{LR} and {k}_{i j}^{LR}$$

are marked respectively with the horizontal and the vertical dashed lines in FIG. 1, graph (d). Similar to the definition of σᵢⱼ in (11), we can define kᵢⱼ as follows:

$$if {σ}_{i j}^{RL} \geq {σ}_{i j}^{LR} then {k}_{i j} = {k}_{i j}^{RL} else {k}_{i j} = {k}_{i j}^{LR} . \qquad ( 14 )$$

kᵢⱼ is the position of the moving windows that result in σᵢⱼ. Next, we propose three approaches to utilize σᵢⱼ and kᵢⱼ to conduct event signature alignment.

### Event Signature Alignment—Approach 1

Let bᵢⱼ denote a binary decision variable to indicate whether waveform xᵢ and waveform yⱼ correspond to the same physical event. This variable can be defined as follows:

$${b}_{i j} = \{ \begin{matrix}1 , & if {x}_{i} and {y}_{j} correspond to the same event , \\ 0 , & otherwise .\end{matrix} \qquad ( 15 )$$

Since the pairing of the event signatures is inherently one-on-one (i.e. an event xᵢ can only be paired with one event yⱼ), the binary variables need to comply with the constraints:

$${\sum }_{j} {b}_{i j} \leq 1 , ∀ {x}_{i} ∈ 𝒳 , {\sum }_{i} {b}_{i j} \leq 1 , ∀ {y}_{j} ∈ 𝒴 . \qquad ( 16 )$$

Next, although the two power quality sensors are not time-synchronized, the local clock at each sensor can help us determine the sequence of the waveform captures at each power quality sensor. For example, from (2), we know that x₁ was captured before x₂, and x₂ was captured before x₃. The method can maintain these sequences when we identify which waveform from set X corresponds to which waveform (if any) from set Y. For instance, it does not make sense to pair x₁ and y₄ while we also pair x₃ and y₂; because this would violate the sequence of the waveforms in sets X and Y. To address this issue, for each i and each j, the following applies:

$${b}_{r s} \leq 1 - {b}_{i j} , ∀ r , s : r < i , s > j . \qquad ( 17 )$$

If bij=1, i.e., xᵢ and yⱼ are deemed to correspond to the same event, then equation (17) becomes bᵣₛ≤0; which means bᵣₛ=0 for any pair of xᵣ and yₛ for which r<i and s>j. If bᵢⱼ=0, i.e., xᵢ and yⱼ are not deemed to correspond to the same event, then equation (17) becomes bᵣₛ≤1; which would not impose any constraint on binary variable bᵣₛ for any r or s.

If the method seeks to pair exactly M waveform captures across the two unsynchronized power quality sensors, then we can have:

$${\sum }_{i} {\sum }_{j} {b}_{i j} = M , \qquad ( 18 )$$

where M is an integer number that is upper bounded by the number of members in set X and the number of members in set Y. That is, M is upper bounded by min {|X|, |Y|}.
1) Optimization with Fixed M: First, suppose M is given. Accordingly, the method pairs exactly M waveform captures across the two power quality sensors. For notional simplicity, the method stacks up bᵢⱼ for all xᵢ∈X and all yⱼ∈Y into vector b. In this regard, the following optimization problem can be proposed:

$${maximize}_{b} {\sum }_{i} {\sum }_{j} {b}_{i j} {σ}_{i j} \qquad ( 19 )$$

subject to equations (15) and (16) and (17) and (18).

The above optimization problem is an integer linear program (ILP). It can be solved using solvers such as CPLEX [26]. The goal of the above optimization is to identify M pairs of event signatures across the two power quality sensors to maximize the total correlation among the paired waveform signatures.

It is helpful to discuss a special case where two unrelated disturbances occur almost at the same time at two different locations. If the two events are sufficiently distanced in time (such as by at least 30 cycles for the SEL power quality meters that we have used in this study), then the two sensors would capture them as two separate events. As a result, each event would be examined separately; just like any other event. However, if the two events are very close to each other in time, then they would fall within a single event-triggered waveform capture. In that case, each sensor would record the two events as a single event, with an inherently combined event signature. The shape of the combined event signature at each sensor would depend on the timing of the two events, as well as the electrical distance between the location of each event and the location of each sensor. If the two combined event signatures match each other, then the two combined events would be paired as part of the solution in equation (19); just like any other pair of events. If the two combined event signatures match each other (such as when one sensor is much closer to the location of one event and the other sensor is much closer to the location of the other event), then the two combined event signatures would not be paired in equation (19) due to low similarity. In that case, the pair of the combined events from this special case would not be used for the purpose of estimating the synchronization operator. The latter outcome would be acceptable; because we can still use several other pairs of events to achieve time synchronization.
2) Finding M: For a given M, let us denote the optimal objective value of the optimization problem in equation (19) by u(M). Increasing M results in adding more non-negative terms to the optimal objective value in (19). However, the amount of increase in u(M) diminishes as we increase M; due to the decreasing similarities between the event signatures of the additional pairs of events. To find the right M, we can start from M=2 and we repeatedly solve equation (19) by incrementing M until we either reach M's upper bound at min {|X|, |Y|} or we drop below a threshold on the amount of increase in the optimal objective value of the optimization problem in equation (19), i.e., until the following stopping criteria is reached:

$$Φ ( M ) {=}^{Δ} \vert u ( M ) - u ( M - 1 ) \vert \leq ϵ . \qquad ( 20 )$$

The value of threshold e can be set based on the minimum required correlation between two event signatures for them to be deemed to correspond to the same physical event.

In practice, there could be disturbances for which the event signatures from different sensors do not align well. For example, this could potentially occur when two unrelated disturbances happen simultaneously at two different locations, as in the special scenario above. Such events are likely not to be paired when solving the optimization in equation (19). However, this would be acceptable; because it is permissible if some event signatures are not paired for the ultimate purpose of time synchronization. What is most important in Step 1 is to have a stopping criterion that yields as many correctly aligned pairs of events as possible from the two sensors. This has a direct implication for the process of finding M: it is not necessary to always determine the exact value of M in Step 1. While the estimation of M may not exceed its true value, it is acceptable to choose an M that is slightly less than the true value. This is because if the estimation of M exceeds its true value, it will result in the inclusion of incorrect event pairs, thereby compromising the accuracy of the synchronization operator estimation in Step 2. Conversely, it is acceptable if the estimation of M is less smaller than the true value, as this still allows for obtaining a sufficient number of correctly aligned pairs of events for estimating the synchronization operator in Step 2.

### Event Signature Alignment—Approach 2

The method in Approach 1 above only utilizes the values of σᵢⱼ, which are based on equations (9)-(11). It does not utilize the values of kᵢⱼ, which are based on equations (12)-(14). In this section, described is Approach 2 to utilize kᵢⱼ instead of σᵢⱼ.

Let [symbol] i denote the sample number in time-series Δxi that corresponds to the starting sample of the moving window that resulted in obtaining kij. Similarly, let [symbol] j denote the sample number in time-series Δyj that corresponds to the starting sample of the moving window that resulted in obtaining kij.

Next, suppose tᵢ denote the time-stamp of sample number κᵢ based on the local clock at the first power quality sensor. Similarly, suppose tⱼ denote the time-stamp of sample number [symbol] based on the local clock at the second power quality sensor. Accordingly, for each pair {xᵢ, yⱼ}, the following can be defined:

$${λ}_{i j} = {t}_{i} - {t}_{j} . \qquad ( 21 )$$

In essence, λij is an estimation of δxy that is obtained solely based on pairing event-triggered time-series xi from the first sensor with event-triggered time-series yj from the second sensor. Whether or not λij is a good estimation of δ xy depends on whether or not xi and yj correspond to the same event.
1) Optimization with Fixed M: For a given M, we propose to replace equation (19) with the following optimization problem:

$${maximize}_{b} {\sum }_{i , r} {\sum }_{j , s} {b}_{i j} {b}_{r s} \vert {λ}_{i j} - {λ}_{r s} \vert \qquad ( 22 )$$

subject to equations (15) and (16) and (17) and (18), where the vector of binary optimization variables b is identical to the one in equation (19). The constraints in equation (22) are also identical to the constraints in equation (19). However, the objective function in equation (22) is different from the objective function in equation (19). Notice that while we maximize the objective function in equation (19), we minimize the objective function in equation (22). To understand this new formulation, we note that if xi and yⱼ are paired together and xᵣ and yₛ are also paired together, then bᵢⱼbrs=1. In that case, the objective function would include |λᵢⱼ−λᵣₛ|, which is the difference between the estimation of synchronization operator δ based on pairing xi and yⱼ and the estimation of synchronization operator δ based on pairing xᵣ and yₛ.

Problem (22) is an integer nonlinear program (INLP). The non-linearity is due to the multiplication of variable bᵢⱼ with variable bᵣₛ.

2) Finding M: For a given M, let us denote the optimal objective value of the optimization problem in equation (22) by v(M). Increasing M results in adding more non-negative terms to the optimal objective value in equation (22). The amount of increase in v(M) depends on the amount of discrepancies among the estimations of the synchronization operator that are obtained from different pairs of event signatures by solving the optimization problem in equation (22). If we exceed the correct number of event signatures that need to be paired, i.e., if we exceed the correct choice of M, then there will be a sudden and major jump in the optimal objective value in equation (22). To find the right M, we can start from M=2 and repeatedly solve equation (22) by incrementing M until we either reach M's upper bound at min {|X|, |Y|} or we exceed a threshold on the amount of increase in the optimal objective value of the optimization problem in equation (22), i.e., until the following stopping criteria is reached:

$$ψ ( M ) {=}^{Δ} \vert υ ( M ) - υ ( M - 1 ) \vert \geq ε . \qquad ( 23 )$$

As we will see in the case studies, the above stopping criteria is robust, i.e., it is not sensitive to the choice of ε. The different direction of the inequalities in equations (23) and (20) is due to the differences between the objective functions in the minimization in equation (22) versus the maximization in equation (19).

### Event Signature Alignment—Approach 3

Approach 1 is computationally efficient; because the optimization in equation (19) is linear. However, Approach 1 is not as robust because the stopping criteria in equation (20) is sensitive to the choice of its threshold. On the contrary, Approach 2 is not computationally efficient because the optimization in equation (22) is nonlinear. However, Approach 2 is robust; because the stopping criteria in equation (23) is not sensitive to the choice of its threshold.

Approach 1 only utilizes the values of σᵢⱼ from equations (9)-(11). Approach 2 only utilizes the values of kᵢⱼ from equations (12)-(14). In this section, we propose a new approach that is both computationally efficient and robust. It utilizes both the values of σᵢⱼ from equations (9)-(11) and the values of kᵢⱼ from equations (12)-(14).
1) Optimization with Fixed M: This aspect in Approach 3 is similar to Approach 1. To obtain vector b, solve the optimization problem in equation (19). Recall that this optimization problem is linear, and it utilizes σᵢⱼ from equations (9)-(11).
2) Finding M: Once we obtained b by solving the optimization problem in equation (19), we use the resulting b to calculate the objective value based on the optimization problem in equation (22). To see this, let us denote the solution from equation (19) by b⁽¹⁹⁾. Let us also denote the solution from equation (22) by b⁽²²⁾. The below list shows the differences and similarities between the stopping criteria in Approach 3 versus in Approach 1 and Approach 2.
Approach 1: Use b₍₁₉₎ to obtain u(M) to check Eq. (20).
Approach 2: Use b₍₂₂₎ to obtain v(M) to check Eq. (23).
Approach 3: Use b₍₁₉₎ to obtain v(M) to check Eq. (23).

Here, the method ensures computational efficiency because the method solves the ILP in equation (19) instead of the INLP in equation (22). Nevertheless, the method still use the formulation of the objective function in equation (22) to find M in a robust fashion. As a result, Approach 3 inherits the key advantages from both Approach 1 and Approach 2.

To better clarify the differences among the above different approaches, let us compare the solutions from problem (19) with the solutions from problem (22). To do so, the method consider the choice of M. For a given M that is less than the true value of M, the solutions from equation (19) may or may not match the solutions from equation (22). In principle, it is possible that both solutions provide correctly aligned pairs for the given choice of M; yet, they provide different subsets of the correctly aligned pairs. If the given M is equal to the true value of M, then a mismatch between the solution from equation (19) and the solution from equation (22) would indicate the presence of at least one incorrect alignment. However, we did not encounter any such case in our various case studies. If the given M is greater than the true value of M, then the solutions from equations (19) and (22) would both include incorrect alignments. In this last scenario, the key question is whether the algorithm would stop due to choice of the stopping criteria in each approach. The stopping criteria in Approaches 2 and 3 based on v(M) are more robust than the stopping criterion in Approach 1 in based on u(M). Of course, the exact values of v(M) can be different under Approach 2 versus under Approach 3 due to the possible differences between the solutions from equations (19) and (22).

### Methodology: Step 2—Statistical Estimation of the Synchronization Operator

Recall above that λᵢⱼ in equation (21) provides an estimation of the synchronization operator δ_{xy} based on pairing the event-triggered time-series xᵢ from the first power quality sensor with the event-triggered time-series yⱼ from the second power quality sensor. However, as we will discuss in this section, there are multiple (often stochastic) factors that can undermine the accuracy of estimating δ_{xy} by using only one pair of time-series xᵢ and yⱼ. Therefore, we need to conduct a statistical analysis based on several pairs of such time series.

### Factors Affecting the Estimation of Parameter δ

Even if xᵢ and yⱼ indeed correspond to the same event, we may still experience some discrepancies between the estimated value λᵢⱼ and the true value δ_{xy}. Broadly speaking:

$${λ}_{i j} = {δ}_{xy} + Difference in Propagation Delay + Error in Data - Driven Event Alignment . \qquad ( 24 )$$

The difference in propagation delay often exists between any two sensor locations, relative to the location of the event. When an event, such as a fault, occurs its impact may not be seen at the same time if the electric distance is not the same between the location of the event and the locations of the two sensors. Importantly, the difference in propagation delay is not fixed. It varies depending on the location of each event.

As for the error in data-driven event alignment, it comes from various sources. Recall above that correlation is used to align the event signatures from different sensors. In practice, it is unlikely that we achieve precise alignment, given the data-driven nature of the analysis. For example, although we extract the differential waveforms to minimize the impact of the background load and other unrelated factors, we cannot fully eliminate such impact. Thus, the event signatures are still distorted. Furthermore, the same physical event can affect the voltage waveforms at each location of the system differently. Hence, the event signatures from different power quality sensors can have major differences; making it practically impossible to exactly align those signatures.

### Statistical Estimation of Parameter δ

In this section, a statistical can be used to estimate δ_{xy}, while considering the challenges discussed above. The goal is to extract δ_{xy} from the following results which come from the methods above:

$${λ}_{i j} , ∀ \{ {x}_{i} , {y}_{j} \} ∈ 𝒳 ⋂ 𝒴 . \qquad ( 25 )$$

Suppose the above values are stacked up in one vector, denoted by λ. The number of rows in λ is equal to the cardinality of set X∩Y. Based on set X∩Y in (3):

$$λ = [ \begin{matrix}{λ}_{2 , 1} \\ {λ}_{3 , 3}\end{matrix} ] . \qquad ( 26 )$$

In practice, vector λ can be a long vector; because set X∩Y can have several members due to pairing several event signatures over a period of several hours or few days. One option to estimate δ_{xy} based on the expected value:

$${\hat{δ}}_{xy} = {1}^{T} λ / \vert λ \vert , \qquad ( 27 )$$

where |λ| denotes the length of vector λ and 1 is a vector with the same length as λ with all entries equal to one. To eliminate outliers, we can use the Median Absolute Deviation (MAD) [28], which is calculated as follows:

$$MAD = median ( \vert λ - median ( λ ) 1 \vert ) . \qquad ( 28 )$$

We can then exclude all entries in λ that are more than γMAD away from median (λ), where γ is often set to 1.4826.

### The Overall Algorithm

The combined process across Step 1 and Step 2 is summarized in Algorithm 1.

Algorithm 1 Combining Step 1 and Step 2

```
  1: Input : Event sets [symbol]  = {xᵢ} and [symbol]  = {yⱼ}. 2:
  Output : Synchronization operator δ_{xy}.
  3: \\ Step 1
  4: Obtain Δxᵢ and Δyᵢ by using (8).
  5: Obtain σᵢⱼ by using (9)-(11).
  6: Obtain kᵢⱼ by using (12)-(14).
  7: For M = 1, . . . , min{| [symbol] |, | [symbol] |} Do
  8:  If Approach 1 or Approach 3 Then
  9:  Obtain b by solving the maximization in Problem (19).
10:  Else \\ Approach 2
11:  Obtain b by solving the minimization in Problem (22).
12:  End If
13:  Set u(M) = ΣᵢΣbᵢⱼσᵢⱼ.
14:   $Set v ( M ) = {\sum }_{i , r} {{\sum }^{j}}_{j , s} {b}_{ij} {b}_{rs} \vert {λ}_{ij} - {λ}_{rs} \vert .$
15:  If M ≥ 2 Then
16:  If Approach 1 Then
17:  Obtain Φ(M) by using u(M) and u(M − 1) in (20).
18:  If Φ(M) ≤ ϵ Then Go To Line 25 End If
19:  Else \\ Approach 2 or Approach 3
20:  Obtain Ψ(M) by using v(M) and v(M − 1) in (23).
21:  If Ψ(M) ≥ ε Then Go To Line 25 End If
22:  End If
23:  End If
24:  Set b* = b and M* = M.
25: End For
26: \\ Step 2
27: Use b* and M* to obtain [symbol]  ∩ [symbol] . 28:
Use [symbol]  ∩ [symbol]  to obtain λ.
29: Exclude outliers in λ by using (28). 30:
Obtain and return δ_{xy} by using (27).
```

The input to Algorithm 1 is the timeseries of all the event-triggered waveform captures at each of the two unsynchronized sensors. The output from Algorithm 1 is the result of estimating the corresponding synchronization operator. Step 1 is implemented from Line 3 to Line 25. Step 2 is implemented from Line 26 to Line 30. A “for loop” is used from Line 7 to Line 25 to determine M. Inside the for loop, we have implemented Approach 1, Approach 2, and Approach 3, which are separated using “if then” structures. Stopping criteria are implemented in Lines 16 and 22, depending on the approach. The outcome of Step 1 is b* and M*, which are updated in Line 24 inside the “for loop” every time that M does not trigger the stopping criteria. The final values of b* and M* are then used in Step 2 to obtain and refine λ in Lines 27 to 30 The algorithm ends by estimating δ_{xy} from λ.

Running Algorithm 1 inherently requires access to sets X and Y; which are the inputs to the algorithm in Line 1. Therefore, we need to first accumulate at least a handful of event-triggered waveform measurements before we can run Algorithm 1. In practice, accumulating one or two days of event-triggered waveform measurements is usually sufficient to construct X and Y, enabling the execution of Algorithm 1.

Once Algorithm 1 is executed and the two sensors are timesynchronized, the subsequent waveform measurements, which will be time-synchronized between the two sensors from that point on, can be used to support various synchro-waveform applications, including real-time applications. In other words, after achieving time-synchronization by Algorithm 1, the subsequent use of the time-synchronized waveform measurements will depend on the desired synchro-waveform application.

As needed, Algorithm 1 can be used on a regular basis to recalibrate time-synchronization. This can be necessary especially if the local clock at some sensors in unreliable and likely to drift, such as due aging, losing power for several hours, or major change in operational temperature. The interval for recalibration can be set by the operator, such as to be daily, weekly, or monthly, depending on the type and age of the sensors and the operational needs. Recalibration can be set up in different ways. One option is to reset X and Y in Line 1 to include only the events that have occurred since the previous recalibration. Another option is to give higher weights to the more recent entries in λ when we estimate δxy in Line 30.

### Extension to Multiple Sensors

So far, we have assumed that the event-triggered waveform measurements come from only two unsynchronized power quality sensors. In this section, we extend the analysis to an arbitrary number of unsynchronized power quality sensors.

Let S denote a set that includes all the sets of the timeseries of the event-triggered waveform measurements that are captured by all the unsynchronized power quality sensors. For example:

$$𝕊 = \{ 𝒳 , 𝒴 , ℨ \} , \qquad ( 29 )$$

where X and Y are defined in (2) and Z is defined in (4).

The methods above to the waveform signatures in any two members in set S. Such pairwise analysis will lead to the following results:

$${\hat{δ}}_{xy} , ∀ 𝒳 , 𝒴 ∈ 𝕊 . \qquad ( 30 )$$

For example, for the scenario above, the following can be obtained:

$${\hat{δ}}_{xy} , {\hat{δ}}_{xz} , {\hat{δ}}_{yz} . \qquad ( 31 )$$

However, the above estimations are not independent. To see this, first, note the following:

$${\hat{δ}}_{xy} = - {\hat{δ}}_{yx} , {\hat{δ}}_{xz} = - {\hat{δ}}_{zx} , {\hat{δ}}_{yz} = - {\hat{δ}}_{zy} . \qquad ( 32 )$$

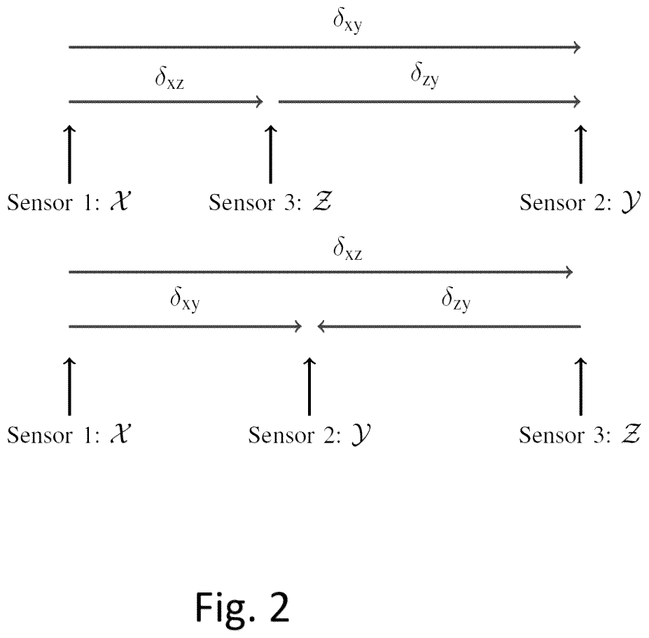

Next, note that:

$${\hat{δ}}_{xy} = {\hat{δ}}_{xz} + {\hat{δ}}_{zy} = {\hat{δ}}_{xz} - {\hat{δ}}_{yz} , \qquad ( 33 )$$

where the second equality is due to (32). The above relationship is illustrated in FIG. 2. The arrangements in this figure are based on the true synchronization operators δ_{xy}, δ_{xz}, and δ_{zy}, where δ_{xy}=δ_{xz}+δ_{zy}. A similar arrangement can hold also among the estimated synchronization operators, as in equation (33).

The relationship in equation (33) can be generalized as follows:

$${\hat{δ}}_{xy} = {\hat{δ}}_{xz} + {\hat{δ}}_{zy} , ∀ 𝒳 , 𝒴 , 𝒵 ∈ 𝕊 . \qquad ( 34 )$$

In FIG. 2, the relationships among synchronization operators. Two scenarios for the sequence of the waveform measurements from three unsynchronized sensors are shown. In the top of the figure, the third sensor has a clock that is behind the clock for the first sensor and ahead of the clock for the second sensor. In the bottom figure, the third sensor has a clock that is behind the c locks for the first sensor and the second sensor. In both scenarios, as well as in every other possible sequence among these three sensors, we have: δxy=δxz+δzy.

Next, there can be two methods that are both built upon equation (34). Both methods can estimate δ between any two unsynchronized power quality sensors. However, the first method seeks to achieve this goal with minimal computation time. Specifically, the first method runs Algorithm 1 for |S|−1 times. Conversely, the second method seeks to take full advantage of the available redundancy to make the results more robust. The second method runs Algorithm 1 for |S|×(|S|−1)/2 times. If the number of sensors is relatively small, then it is recommended to use the second method. If the number of sensors is relatively large, then it is recommended to use the first method.

Method without Utilizing Redundancy

Suppose the system is working with a large number of unsynchronized sensors, all of which provide event-triggered waveform:

$$𝕊 = \{ 𝒜 , ℬ , 𝒞 , 𝒟 , … , 𝒳 , 𝒴 , 𝒵 \} . \qquad ( 35 )$$

In the first method, we propose the following:
Run Algorithm 1 between A and B to estimate δ_{ab}.
Run Algorithm 1 between B and C to estimate δ_{bc}.
Run Algorithm 1 between C and D to estimate δ_{cd}.
Run Algorithm 1 between X and Y to estimate δ_{xy}.
Run Algorithm 1 between Y and Z to estimate δ_{yz}.

Thus, the method can run the algorithm |S|−1 times to obtain:

$${\hat{δ}}_{ab} , {\hat{δ}}_{bc} , {\hat{δ}}_{cd} , … , {\hat{δ}}_{xy} , {\hat{δ}}_{yz} . \qquad ( 36 )$$

Note that Algorithm 1 can be run in parallel for the above separate estimations. From equations (36) and (34), the method can estimate δ between any two sensors. For example, for the first sensor, the method can estimated δab in equation (36). Using equation (34), we can also estimate:

$${\hat{δ}}_{ac} = {\hat{δ}}_{ab} + {\hat{δ}}_{bc} \qquad ( 37 )$$

$${\hat{δ}}_{ad} = {\hat{δ}}_{ab} + {\hat{δ}}_{bc} + {\hat{δ}}_{cd}$$

$$⋮$$

$${\hat{δ}}_{az} = {\hat{δ}}_{ab} + {\hat{δ}}_{bc} + {\hat{δ}}_{cd} + … + {\hat{δ}}_{xy} + {\hat{δ}}_{yz} .$$

Method with Utilizing Redundancy

The method in Section V-A has low computational complexity to be applicable to a large number of sensors. Next, we propose another method that leverages redundancy for increased robustness, but with higher computational complexity. From equation (34), there are two ways to estimate δ_{xy}:
Directly from X∩Y, and
Indirectly from X∩Z and Z∩Y, for any Z∈S\{X,Y}.

Together, the above two options can provide us with a total of

$$1 + ( \vert 𝕊 \vert - 2 ) = \vert 𝕊 \vert - 1 \qquad ( 38 )$$

different estimations for δxy. This provides us with significant redundancy in our estimation process as we increase the number of unsynchronized power quality sensors. For instance, the following average can be taken as the ultimate estimation:

$$\frac{1}{\vert 𝕊 \vert - 1} ( {\hat{δ}}_{xy} + {\sum }_{𝒵 ∈ 𝕊 \backslash \{ 𝒳 , 𝒴 \}} {\hat{δ}}_{xz} + {\hat{δ}}_{zy} ) . \qquad ( 39 )$$

As a special case, estimations can be limited in equation (39) to only those events that have been captured by all the available unsynchronized power quality sensors. In that case, the focus would be only on the events that belong to the intersection of all the sets in set S, such as X∩Y∩Z for the case in equation (35).

### Experiments

In this section, described is of use real-world waveform measurements to assess the performance of the proposed methods. Three Schweitzer Engineering Laboratories (SEL) 735 Power Quality Meters are used to conduct our experiments. All three sensors are equipped with GPS signal receivers, utilizing the SEL 2401 Satellite-Synchronized Clock to ensure precise time synchronization among the measurements. Throughout the case studies, the staff was consistently aware of the ground truth regarding the timing of all waveform measurement samples and the values of the synchronization operators. Two sensors are installed at 480 V (three-phase), and one sensor is installed at 12.47 kV (three-phase). The sampling rate for all waveform measurements is 128 samples per cycle. Each event capture contains 62 cycles, i.e., 7,936 measurement samples, based on a common setting for the SEL 735. The duration of the events varies, such as from only a quarter of a cycle to several cycles.

Comparison with Prior Art

In this section, compare are the performance of the system and method described herein with a prior art method with. One prior art method seeks to solve the same requiring the number of unsynchronized power quality sensors to be limited to two. Accordingly, we consider a scenario with two unsynchronized sensors. The first sensor captures 28 events. The second sensor captures 53 events during the same period. In this regard:

$$\vert 𝒳 \vert = 28 and \vert 𝒴 \vert = 53. \qquad ( 40 )$$

Among the two sensors, there are |X∩Y|=5 events that are paired, i.e., they were captured by both sensors. Set X∩Y comprises the following pairs of event-triggered time-series:

$$\{ {x}_{1} , {y}_{1} \} , \{ {x}_{2} , {y}_{2} \} , \{ {x}_{3} , {y}_{3} \} , \{ {x}_{4} , {y}_{21} \} , \{ {x}_{5} , {y}_{23} \} . \qquad ( 41 )$$

TABLE II
COMPARISON BETWEEN THE PROPOSED METHOD
(APPROACH 3) AND THE METHOD IN [24]

| | Reference [24] | | Proposed Method | |
|---|---|---|---|---|
| M | Event Pairs | Stop Criteria | Event Pairs | Stop Criteria |
| 1 | {x₁, y₁} | 0.180 | {x₁, y₁} | — |
| 2 | {x₁, y₁} | 0.385 | {x₁, y₁} | 0 |
| | {x₂, y₂} | | {x₂, y₂} | |
| 3 | {x₁, y₁} | 0.610 | {x₁, y₁} | 0.466 |
| | {x₂, y₂} | | {x₂, y₂} | |
| | {x₃, y₃} | | {x₃, y₃} | |
| 4 | {x₁, y₁} | 0.868 | {x₁, y₁} | 0.483 |
| | {x₂, y₂} | | {x₂, y₂} | |
| | {x₃, y₃} | | {x₃, y₃} | |
| | {x₄, y₂₁} | | {x₄, y₂₁} | |
| 5 | {x₁, y₁} | 1.205 | {x₁, y₁} | 0.490 |
| | {x₂, y₂} | | {x₂, y₂} | |
| | {x₃, y₃} | | {x₃, y₃} | |
| | {x₄, y₂₁} | | {x₄, y₂₁} | |
| | {x₁₄, y₂₂} | | {x₅, y₂₃} | |
| 6 | {x₁, y₁} | 1.583 | {x₁, y₁} | 146422 |
| | {x₂, y₂} | Stop: M = 5 | {x₂, y₂} | Stop: M = 5 |
| | {x₃, y₃} | | {x₃, y₃} | |
| | [symbol] | | [symbol] | |
| | [symbol] | | [symbol] | |
| | [symbol] | | [symbol] | |

[symbol]

indicates data missing or illegible when filed

Table II provides a detailed comparison between the proposed method (Approach 3) and the prior art method in. For both methods, M is changed from 1 to 6, and provide the list of the events that are paired and the stopping criteria accordingly. First, notice that the stopping criteria in both methods correctly identify the number of pairs to be M=5=|X∩Y|. However, the process to find M is much more robust in the proposed method, where the stop index goes from 0.490 to 146422, versus in the method in the prior art (shown as [24] in Table II), where the stop index goes from 1.205 to 1.583. The latter is only a 30% increase while the former is a 300,000 fold increase. Therefore, the currently described method is much more robust in its stopping criteria.

Furthermore, at M=5, the outcome of the event alignment from the prior art method in is incorrect, while the outcome of the event alignment from the currently described method is correct. In fact, the prior art method identified {x14, x22} as a pair, which is incorrect. The correct pair is rather {x5, x23}, as in equation (41).

Regarding the last row in Table II, at M=6, the analysis in this row is an auxiliary analysis that triggers the stopping criteria to identify M=5. Accordingly, the event pairs in this row are not useful. Only the stopping criteria is useful in this row.

It is useful to compare the runtime between our method (Approach 3) and the prior art method. The runtime for our (Approach 3) was 43 minutes. The runtime for the prior art method was almost 60 days, i.e., almost 2000 times longer. In fact, it was impossible to use a single PC to run the prior art method. The testers had to use multiple PCs as well as cloud resources, all in parallel, with a total runtime adding up to 60 days. The much better runtime for currently described method was due to using the new metric above to compare the event signatures.

### Comparison Among Approaches 1, 2, and 3

Next, the three methods that described herein can be compared, for example, using two unsynchronized sensors. The first sensor captures 10 events. The second sensor too captures 10 events during the same period. |X|=|Y|=10. Among the two sensors, there are |X∩Y|=5 events that are paired, i.e., they were captured by both sensors. Set X∩Y comprises the following pairs of event-triggered time-series:

$$\{ {x}_{1} , {y}_{1} \} , \{ {x}_{2} , {y}_{2} \} , \{ {x}_{3} , {y}_{3} \} , \{ {x}_{4} , {y}_{8} \} , \{ {x}_{5} , {y}_{10} \} . \qquad ( 42 )$$

The above scenario is smaller than the scenario above. This is because Approach 2 is computationally complex, much more so than Approaches 1 and 3. Hence, in order to compare all three methods, we need to consider a smaller case.

Importantly, Approaches 1, 2, and 3 can all provide correct results for event alignment, i.e., they all achieve equation (42). However, these three methods are different in terms of their runtime and robustness. This is shown in Table III. First, note that the runtime for Approaches 1 and 3 is very low, while the runtime for Approach 2 is high. For instance, at M=5, the runtime for Approaches 1 and 3 is a small fraction of a second, while the runtime for Approach 2 is 3347 seconds (˜56 minutes).

TABLE III
COMPARING RUNTIME AND ROBUSTNESS ACROSS APPROACHES 1, 2, AND 3.

| | Approach 1 | | | Approach 2 | | | Approach 3 | | |
|---|---|---|---|---|---|---|---|---|---|
| | Event | Stop Criteria | | Event | Stop Criteria | | Event | Stop Criteria | |
| M | Pairs | Φ(M) | Runtime | Pairs | Ψ(M) | Runtime | Pairs | Ψ(M) | Runtime |
| 1 | {x1, y1} | — | — | {x1, y1} | — | — | {x1, y1} | — | — |
| 2 | {x1, y1} | 0.93 | 0.04 | {x1, y1} | 0.01 | 650 | {x1, y1} | 0.01 | 0.05 |
| | {x2, y2} | | | {x2, y2} | | | {x2, y2} | | |
| 3 | {x1, y1} | 0.91 | 0.04 | {x1, y1} | 0.32 | 1537 | {x1, y1} | 0.32 | 0.05 |
| | {x2, y2} | | | {x2, y2} | | | {x2, y2} | | |
| | [symbol] | | | [symbol] | | | [symbol] | | |
| 4 | {x1, y1} | 0.80 | 0.04 | {x1, y1} | 0.77 | 2442 | {x1, y1} | 0.77 | 0.04 |
| | {x2, y2} | | | {x2, y2} | | | {x2, y2} | | |
| | {x3, y3} | | | {x3, y3} | | | {x3, y3} | | |
| | [symbol] | | | [symbol] | | | [symbol] | | |
| 5 | {x1, y1} | 0.78 | 0.05 | {x1, y1} | 1.23 | 3347 | {x1, y1} | 1.23 | 0.05 |
| | {x2, y2} | | | {x2, y2} | | | {x2, y2} | | |
| | {x3, y3} | | | {x3, y3} | | | {x3, y3} | | |
| | [symbol] | | | [symbol] | | | [symbol] | | |
| | [symbol] | | | [symbol] | | | [symbol] | | |
| 6 | {x1, y1} | 0.04 | 0.15 | {x1, y1} | 21114 | 4089 | {x1, y1} | 146422 | 0.33 |
| | {x2, y2} | Stop: M = 5 | | {x2, y2} | Stop: M = 5 | | {x2, y2} | Stop: M = 5 | |
| | {x3, y3} | | | {x3, y3} | | | {x3, y3} | | |
| | [symbol] | | | [symbol] | | | [symbol] | | |
| | [symbol] | | | [symbol] | | | [symbol] | | |
| | [symbol] | | | [symbol] | | | [symbol] | | |

[symbol]

indicates data missing or illegible when filed

Next, let us consider the robustness in the stopping criteria. Approach 1 uses the criteria in equation (20), which requires Φ(M) to drop below a threshold. To assess robustness, we notice that at M=6, we have: Φ(M−1)/Φ(M)=0.78/0.04≈20. Approaches 2 and 3 use the criteria in equation (23), which requires Ψ(M) to exceed above a threshold. To assess robustness, we notice that at M=6, we have: Ψ(M)/Ψ(M−1)=21114/1.23≈17166 for Approach 2, and Ψ(M)/Ψ(M−1)=146422/1.23≈119042 for Approach 3. Therefore, Approach 2 and Approach 3 are more robust; because they demonstrate a drastically higher change in their metric for stopping criteria, which makes it much easier to find the correct value of M.

Table III also shows the solutions from each method for pairing the events. Recall that Approaches 1 and 3 solve Problem (19) while Approach 2 solves problem (22). When M≤5, the event pairing solutions are the same in each row. However, when M=6, which is when the choice of M exceeds the true value of M, the event pairing solutions become different. In fact, all three approaches result in some incorrect event pairs in this last row; however, those incorrect results are not the same. To see this, notice that the last three (gray) pairs at M=6 under Approaches 1 and 3 are different from the last three pairs at M=6 under Approach 3. As a result, the value of Ψ(M=6) is different in Approach 2 from the value of Ω(M=6) in Approach 3.

### Accuracy in Estimating δ

Once the event signatures are aligned, the next step is to estimate the synchronization operator. Consider the scenario in Section VI-B, where |X|=|Y|=10 and |X∩Y|=5. The true value for the synchronization operator is set to δxy=100 milliseconds. Using M=5 pairs of aligned event signatures, we obtain the following values for λij, all in milliseconds:

$$106.34 , 105.43 , 138.23 , 103.26 , 120.11 . \qquad ( 43 )$$

From (27), we can obtain \hat{ }δxy=114.7 milliseconds, which has 14.7% error. From (28), and by setting γ=1.4826, we can use MAD to exclude two outliers at 138.23 and 120.11 milliseconds. Accordingly, we obtain \hat{ }δxy=105.0 milliseconds, which has 5% error. Thus, with as few as only five aligned event signatures, we can achieve reasonable accuracy in estimating δ. In practice, one can use event-triggered waveform measurements over multiple days; thus increasing the number of pairs of aligned waveform signatures. This can further improve accuracy due to increased redundancy in data.

The percentage of error in estimating δ can significantly reduce (improve) if the true value of δ increases. For example, if δ is 1 second, then the percentage error can be much less than 1%. This is because the amount of error in estimating δ is almost fixed, regardless of the value of δ. Such error depends on two types of factors, as we listed in equation (24). Both of those factors are within microseconds to few milliseconds. Therefore, for a higher δ, the value of |δ−\hat{ }δ| reduces in percentage; resulting in a smaller percentage error.

### Importance of Sequence Constraints

The optimization-based methods described herein use various constraints. The constraint in equation (17) is distinctly subtle. It hold the sequence of the events at each unsynchronized sensor.

In this section, the importance of including the constraint in equation (17) is discussed as part of the optimization-based method in Approach 3. The results are shown in Table IV. The case study above is repeated for Approach 3, but this time we remove constraint (17) from the optimization problem formulation in equation (19). Interestingly, removing constraint equation (17) can significantly reduce the runtime in Approach 3. Recall above that Approach 3 with constraint (17) takes several minutes to run. However, the runtime for Approach 3 without constraint (17) is only a fraction of a second.

TABLE IV
APPROACH 3 WITHOUT THE SEQUENCE
CONSTRAINTS IN (17)

| M | Event Pairs | Stop Criteria | Runtime |
|---|---|---|---|
| 1 | — | — | — |
| 2 | {x₁, y₁} | 0.00 | 0.25 |
| | {x₂, y₂} | | |
| 3 | {x₁, y₁} | 0.47 | 0.10 |
| | {x₂, y₂} | | |
| | {x₄, y₂₁} | | |
| 4 | {x₁, y₁} | 48792 | 0.10 |
| | {x₂, y₂} | Stop: M = 3 | |
| | {x₁₄, y₂₂} | | |
| | {x₄, y₂₁} | | |

Nevertheless, removing constraint (17) from the optimization problem in (19) can lead to incorrect results. This is evident from the column on event pairs and the column on stop criteria in Table IV. Not only some of the paired events are incorrect, but also the choice of parameter M is incorrect. The incorrect results are marked in red in Table IV. Therefore, it is necessary to include the sequence constraints in constraint (17) in the proposed optimization-based methods above.

### Impact of Data-Driven Factors

Several factors can affect the data-driven estimation of the synchronization operator. For a given pair of correctly aligned event signatures {xᵢ, yⱼ}, we almost always have some mismatch between λᵢⱼ in equation (21) and the true value of δ_{xy}. This was previously discussed in equation (24).

To see this, again consider the five pairs of event-triggered time-series in equation (42) that we previously discussed above. The corresponding values of λᵢⱼ are obtained as:

λ_{1,1} based on {x₁,y₁} is 6.34 milliseconds,

λ_{2,2} based on {x₂,y₂} is 5.43 milliseconds,

λ_{3,3} based on {x₃,y₃} is 32.23 milliseconds,

λ_{4,8} based on {x₄,y₈} is 3.26 milliseconds,

λ_{5,10} based on {x₅,y₁₀} is 20.11 milliseconds. (44)

In theory, the above values can be equal; since they all estimate the synchronization operator between the same two sensors. However, in practice, these values are different. The differences are due to the various data-driven factors that explained above. Using equation (27), we can combine all the results in equation (44) to obtain δ\hat{ }_{xy}=14.67 milliseconds.

a Case with More than Two Sensors

In this section, we use real-world waveform measurements from three sensors. The first sensor captures 17 events. The second sensor captures 19 events. The third sensor captures 12 events. Accordingly, we can construct set S as in (35), where:

$$\vert 𝒳 \vert = 17 , \vert 𝒴 \vert = 19 , \vert 𝒳 \vert = 12 , \vert 𝒳 ⋂ 𝒴 ⋂ 𝒵 \vert = 10. \qquad ( 45 )$$

The true values for the synchronization operator are as follows, all in milliseconds: δ_{xy}=60, δ_{xz}=100, and δ_{yz}=40.

Table V shows the results. The first column shows all the event signatures from the three sensors that are aligned with each other by Approach 3. The second column shows the data driven estimation of λᵢⱼ for the aligned events between the first and the second sensors. The third column shows the data driven estimation of λᵢⱼ for the aligned events between the first and the third sensors. The last column shows the data-driven estimation of λᵢⱼ for the aligned events between the second and the third sensors. The definition of λᵢⱼ is given equation (21).

TABLE V
ALIGNED EVENTS AND ESTIMATION RESULTS
FROM THREE SENSORS AS IN (45)

λᵢⱼ in milliseconds

| Aligned Event Signatures | {x, y} | {x, z} | {y, z} |
|---|---|---|---|
| {x₃, y₄, z₁} | 60.22 | 101.74 | 41.52 |
| {x₅, y₆, z₂} | 60.13 | 117.72 | 57.46 |
| {x₇, y₉, z₄} | 60.22 | 98.44 | 38.17 |
| {x₁₀, y₁₂, z₅} | 60.22 | 131.76 | 71.63 |
| {x₁₁, y₁₃, z₆} | 60.17 | 131.80 | 71.63 |
| {x₁₂, y₁₄, z₇} | 60.17 | 114.47 | 54.29 |
| {x₁₄, y₁₆, z₉} | 59.35 | 95.48 | 36.05 |
| {x₁₅, y₁₇, z₁₀} | 74.60 | 112.51 | 37.91 |
| {x₁₆, y₁₈, z₁₁} | 58.35 | 95.92 | 37.52 |
| {x₁₇, y₁₉, z₁₂} | 74.68 | 110.21 | 35.40 |

By using the analysis in (28), we remove several outliers for each pair of sensors, including four entries of λᵢⱼ for {x, y}, two entries of λᵢⱼ for {x, z}, and four entries of λᵢⱼ for {y, z}.

First, suppose we use the method without redundancy. This method would require running Algorithm 1 by |S|−1=2 times. From (27), we can use the results in Table V to estimate δ for |S|−1=2 pairs of sensors:

$${\hat{δ}}_{xy} = 60.19 , {\hat{δ}}_{yz} = 37.76 . \qquad ( 46 )$$

From equation (46), together with equation (37), the following can be obtained:

$${\hat{δ}}_{xz} = {\hat{δ}}_{xy} + {\hat{δ}}_{yz} = 97.95 . \qquad ( 47 )$$

Next, suppose we use the method with redundancy. This method would require running Algorithm 1 by |S|×(|S|−1)/2=3 times. Two runs of Algorithm 1 would provide the same estimations as in (46). The third run, i.e., the additional run, will use Table V to further provide:

$${\hat{δ}}_{xz} = 105.81 . \qquad ( 48 )$$

From equation (39), to combine the results in equations (46) and (48) to obtain:

$$( 105.81 + 97.95 ) / 2 = 101.88 . \qquad ( 49 )$$

By comparing equations (46) and (49), it can be seen that both methods provide acceptable results for δ\hat{ }_{xz}; however, the results from the second method in equation (49) is more accurate than the results from the first method in equation (46) in this case.

### Example Application: Monitoring DER Dynamics

Time-synchronizing waveform measurements from ordinary power quality sensors can be used in a wide range of applications in power systems, especially in power distribution systems where access to GPS-synchronized waveform measurements is limited. One such application is in studying the dynamic behavior of inverter-based distributed energy resources (DERs) in response to various disturbances in power systems. Such analysis can shed light on how different events may potentially disrupt the operation of DERs. This will allow distribution system operators to plan accordingly.

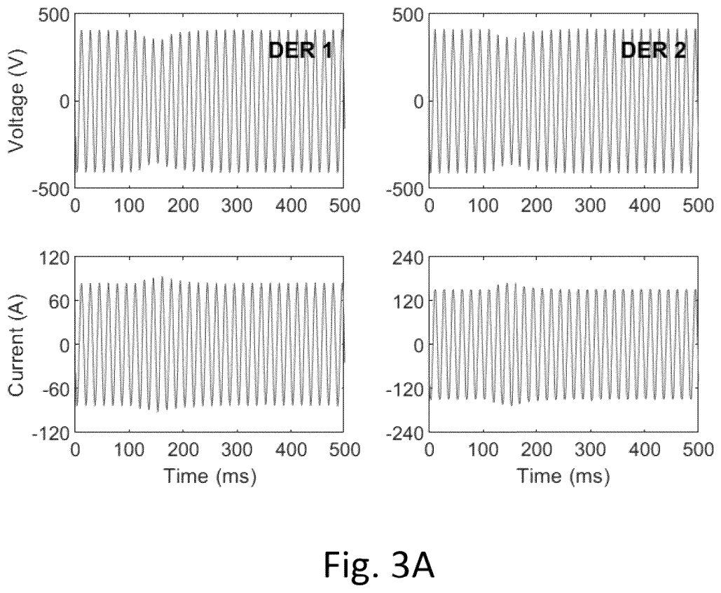

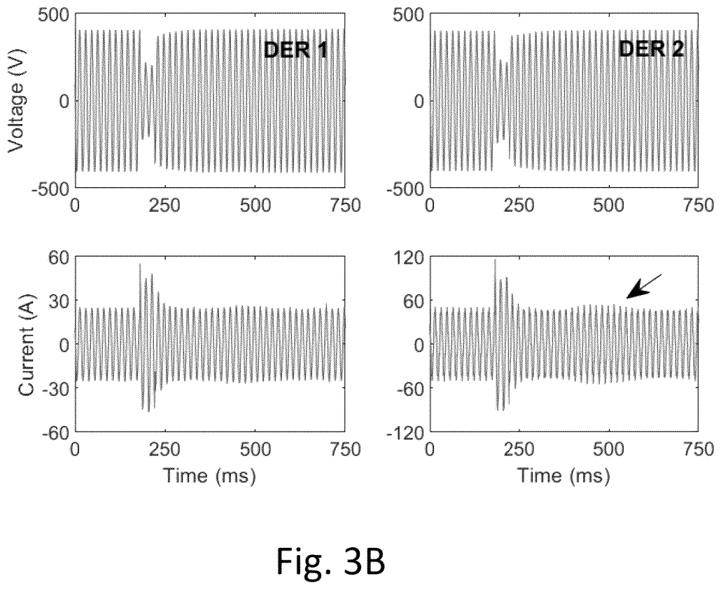

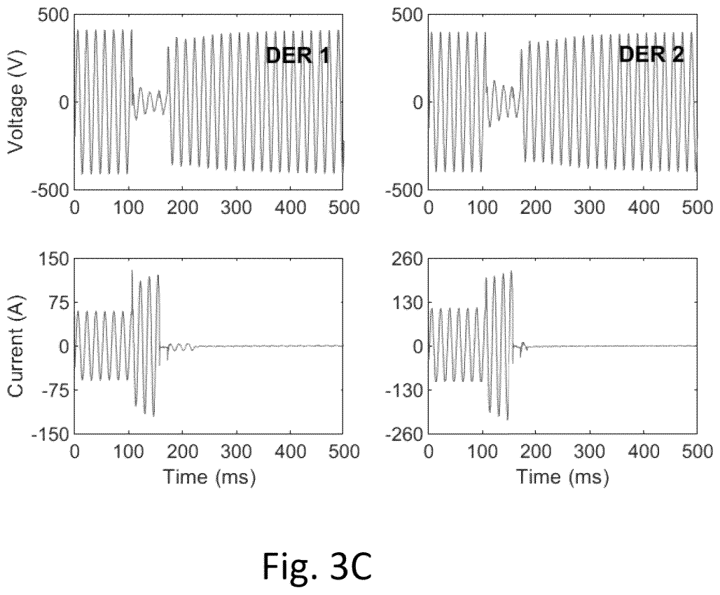

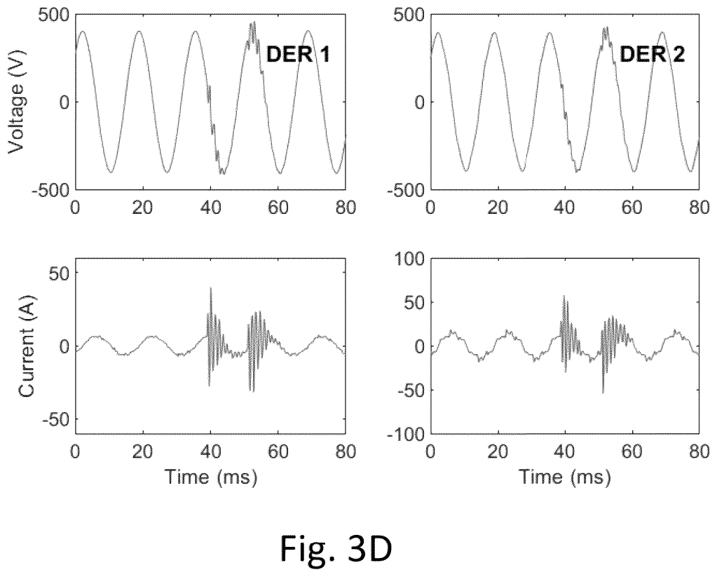

With reference to FIGS. 3A-3D, an example shown of time-synchronized waveforms from two power quality meters at two PV units during four different disturbances. Both PV units are DERs. They are interconnected at 480 V at two different locations. The inverters of the two PV units are from the same manufacturer; however, the two PV units have different sizes, with up to 100 kW and 200 kW rated generation capacity, respectively. The disturbances are as follows:
Voltage Sag: FIG. 3A shows the simultaneous responses of the two PV units to a voltage sag. Both PV units momentarily experience slight increases in their injected current; with no major impact on their normal operation.
Fault with Ride-through: FIG. 3B shows the simultaneous responses of the two PV units to a fault in the power system, where both PV units experience significant agitation. Nevertheless they both manage to ride through the fault. Notice the “bump” in the dynamic response of DER 2 that is marked with an arrow. This shows the visible presence of low-frequency modulated oscillations at about 5 Hz that are likely developed in the inverter's phase locked loop control system due to the disturbance that the fault caused in the inverter's terminal voltages. A similar phenomena also appears in the dynamic response of DER 1 to the same fault; but it is less significant (and harder to see) in DER 1.
Fault without Ride-through: FIG. 3C shows the simultaneous responses of the two PV units to another fault in the power system. In this case, both PV units trip during the fault. However, they do not trip exactly at the same time. They also demonstrate slightly different dynamic behavior during their tripping.
Oscillations: FIG. 3D shows the simultaneous damping oscillations that occurred at the two PV units in response to another fault in the power system. The frequency of the oscillations at both PV units is around 1 kHz.

These and other similar analysis can be used not only to model the dynamic behavior of DERs, but also to conduct benchmarking and health monitoring of DERs. For instance, one can compare how different DERs (from the same vendor or from different vendors) within a certain distribution or subtransmission system respond to the same disturbances. Such comparison can lead to early detection of DER malfunctions. It can also be used to fine-tune the control parameters of the DERs by using the desirable responses of other similar DERs as reference points. The results will also directly help network operators to better predict and prepare for the dynamic responses of DERs to various disturbances as the penetration of DERs continues to grow in their network.

Time-synchronizing waveform measurements can also support other applications in distribution systems, such as event and fault location identification on distribution feeders, wildfire monitoring in distribution networks, and power distribution system protection.

Put alternatively, in some embodiments, the disclosed systems and methods for aligning the unsynchronized event signatures may comprise a fast and accurate metric for comparing event signatures and determining parameters associated with similarity and the position between two waveforms, an optimization framework that uses the similarity and the position as inputs to identify event pairs associated with the same physical event, without time-synchronization, a statistical framework for determining a time-shift using the identified event pairs, and an expansion of these methods to a large number of unsynchronized sensors taking into account the redundancies of corresponding time-shifts.

In some cases, a power quality sensor may record or capture a waveform when it detects an event. In some cases, a power quality sensor at one location may capture an event and another power quality sensor at another location may not capture the same event. This may happen because the same physical event can affect the voltage and current waveforms at each location of the power system differently from the other locations on the same network. The strategy for event capture may also differ among different sensors. As a result, the set of events that are captured by one power quality sensor can be different from the set of the events that are captured by another power quality sensor. Accordingly, a first aspect of the synchronization problem may comprise identifying pairs of event signatures, herein referred to as event pairs, in different signals (e.g., waveforms, or time-series) received from the two unsynchronized power quality sensors (herein referred to as sensors), where a pair of event signatures (or an event pair) indicate the same event detected and/or measured by the two unsynchronized power quality sensors.

In some cases, the synchronization algorithm may comprise a pairing method (e.g., an optimization-based pairing method) that can identify pairs or groups of event signatures associated with an event (an actual physical event). In some cases, the pairs or groups of event signatures may be identified without using a stop criterion. In some cases, an objective value can be used to identify a pair or a group of event signatures associated with an event captured by two or more power quality sensors.

Advantageously, the disclosed methods, may allow pairing event signatures in two or more sets of event signatures, each received from a different power quality sensor, where at least two sets of event signatures include different numbers of event signatures. For example, X may denote a first set of event signatures captured by a first sensor and Y may denote a second set event signatures captured by a second sensor, e.g., in the same network and during the same period. In some cases, three event signatures may be captured by the first sensor, and four event signatures may be captured by the second sensor (e.g., X={x1, x2, x3} and Y={y1, y2, y3, y4}).

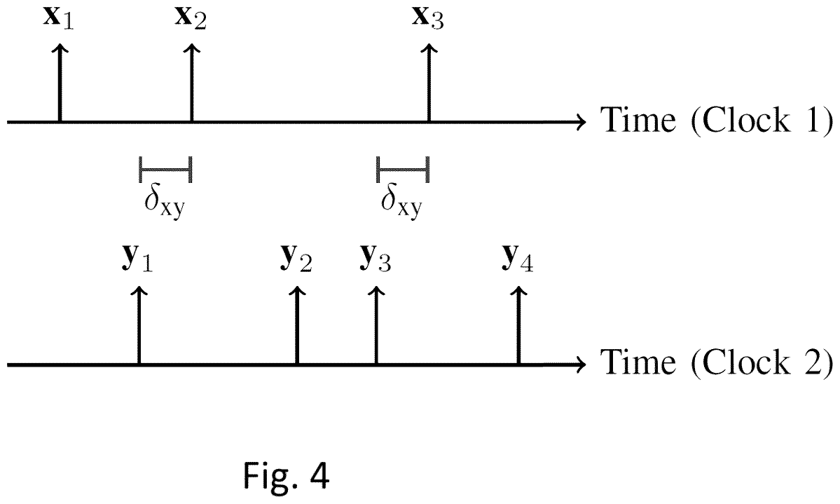

With reference to FIG. 4, a flow diagram schematically illustrates two time-series (e.g., two signals) comprising the two sets of event signatures captured by the first (top) and second (bottom) power quality sensors. In some cases, the first and second sensors may have local clocks based on which the first and second sets of event signatures are generated. In some cases, the first local clock (Clock 1) used by the first sensor may not be synchronized with the second local clock (Clock 2) used by the second sensor.

In FIG. 4, the arrows in the tops and bottom time-series indicate the timing of the event signatures (and corresponding waveforms) captured by the first and second (bottom) sensors, respectively.

In some embodiments, a waveform synchronization system may use the event pairing method to pair an event signature in the first time-series with an event signature in the second time-series. For example, waveform synchronization system may use the event pairing algorithm to pair the second event signature (x2) of the first set X with the first event signature (y1) of the second set Y and to align the third event signature (x3) of the first set X with the third event signature (y3) of the second set Y. In some cases, the pairing algorithm may identify and align event pairs based on a similarity criteria for evaluating a similarity of two waveform patterns and to determine that two event signatures from two different sets of event signatures should be paired. In the examples, shown the remaining event signatures, x1, y2, and y4, may be different event signatures each captured by one of the two sensors.

In various implementations the pairing algorithm may comprise: deriving differential waveforms for a pair of the waveforms received from the sensors (e.g., using an equation similar to Equation (8) above, which represents the differential waveforms for two waveforms), determining two correlation coefficients based on the differential waveforms and selected time-windows and determining the maximum values of individual ones of the two correlation coefficients over respective time-windows (e.g., using equations similar to equations (9) and (10) above), and determining a similarity condition (or metric) for the pairs of event signatures based on the determined maximum values of the individual ones of the two correlation coefficients. In some cases, the similarity metric for two event signatures may comprise the greater of maximum values of a left and a right correlation coefficient and may indicate the maximum correlation coefficient that can be achieved between two event signatures xi and yj, each from a waveform received from a different sensor, among all possible alignments between a window with a length of at least half of the samples (e.g., using an equation similar to equation (11) above).

In some embodiments, the pairing algorithm may comprise identifying the event pairs by determining time stamps associated with maximum values of the two correlation coefficients (left and right correlation coefficients) and identifying the pair of event signatures based at least in part on the time stamps. In some cases, the pairing algorithm may use both the time stamps and the maximum values of the two correlation coefficients to identify the event signature.

In some embodiments, after identifying event pairs, the waveform synchronization system, may determine a synchronization factor δ_{xy} or operator δ_{xy} between the two time-series and the respective sensors. In some cases, the synchronization factor δ_{xy} or operator δ_{xy} may indicate a time shift (or delay) between the two time series. In some cases, a time difference (λᵢⱼ=tᵢ−tⱼ) between two paired events in the first and second sets of events, which are identified as being associated with the same event, may not be an accurate estimation of δ_{xy}, e.g., due to discrepancies that can be stochastic in nature. Accordingly, a second aspect of the synchronization problem may comprise a statistical analysis based on several event pairs identified in the first and second time series. In some examples, λᵢⱼ can be substantially equal to sum of δ_{xy}, a difference in propagation delay, and an error in data-driven event alignment.

In some embodiments, a waveform synchronization system may use a time-shift estimation algorithm determine a time-shift between two unsynchronized signals received from two different sensors based on event pairs identified, e.g., using the pairing algorithm described above or another pairing algorithm.

In some implementations, the time-shift estimation algorithm may comprise determining time stamps for individual event signatures of an identified pair of event signatures, generating an event vector based on difference between the time stamps, and determining a synchronization operator using the event vector. In some cases, time-shift estimation algorithm may comprise determining the time-shift by performing a statistical analysis based on the event vector (e.g., using an equation similar to equation (27). In some implementations, the event vector may be generated using a time stamp associated with a plurality of event pairs in a plurality of sensor signals received from two sensors. In some cases, the statistical analysis may comprise determining a Median Absolute Deviation (MAD) using the event vector (e.g., using an equation similar to equation (28) above).

In some implementations, the time-shift estimation algorithm may comprise determining time stamps for individual event signatures of an identified pair of event signatures, generating an event vector based on difference the determined time stamps.

In some implementations, the time-shift estimation algorithm may be configured to determine a time-shift between two even signatures of an identified event pair by: determining a first differential shift parameter indicating difference between zero-crossing points of the first and second signals, determining a second differential shift parameter indicating difference between event-starting points of the first and second event signatures; determining the time-shift based on the first and second differential shift parameters, and performing a statistical analysis based on the first and second differential shift parameters. In some cases, the time-shift estimation algorithm may be further configured to estimate the time-shift by determining an expected value based on a plurality of differential shift parameters determined for a plurality of event pairs, wherein the plurality of event pairs are identified in a plurality of sensor signals received from the first and second sensors.

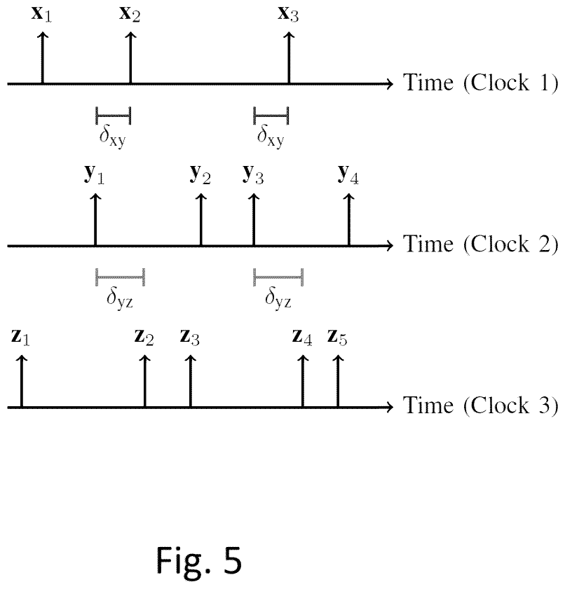

In some embodiments, when time series captured by more than two sensors are synchronized, the two aspects of the synchronization problem can be more complicated. FIG. 5 is a diagram that schematically illustrates three time series corresponding to waveform measurements captured by three different sensors that are not time synchronized. In some cases, X can be a first set of events captured by the first sensor, Y can be a second set of event captured by the second sensor, and Z can be a third set of the events captured by the third sensor, where X={x1, x2, x3}, Y={y1, y2, y3, y4}, and Z={z1, z2, z3, z4, z5}. In some cases, the first, second, and third local clocks (Clock 1, Clock 2, Clock 3) used by the first, second, and third power quality sensor may not be synchronized. In some cases, a group of event signatures As indicated in FIG. 5, may comprise two sets of event signatures {x2, y1, z2} and {x3, y3, z4}.

Extending the example to the case with three power quality sensors, the unknown synchronization operators between the first and the second sensors, and the second and the third sensors are denoted by δxy and δyz respectively. In some embodiments, the methods described above with respect identifying the event pairs in signals generated by two different sensors and determine a time-shift for aligning the signals received from the two different sensors may be applied to an two members of the set S={X,Y,Z}. In some embodiments, determining synchronization operators for signals received from three or more sensors may result in significant redundancy in the time-shift estimation process. In some cases, an average time-shift may be estimated using an equation similar to equation 36 above.

Other embodiments will be apparent to those of ordinary skill in the art from the disclosure herein. Moreover, the described embodiments have been presented by way of example only, and are not intended to limit the scope of the inventions. Rather, a skilled artisan will recognize from the disclosure herein a wide number of alternatives for the exact ordering of the image processing steps. Other arrangements, configurations, and combinations of the embodiments disclosed herein will be apparent to a skilled artisan in view of the disclosure herein and are within the spirit and scope of the inventions as defined by the claims and their equivalents.

Any combination of features described in these appendices can be implemented in combination with aspects described above. Moreover, any combination of features described in two or more of the appendices can be implemented together. As a non-limiting example, any of the features recited in the summary of certain aspects can be combined with any of the features recited herein.

Reference to any prior art in this specification is not, and should not be taken as, an acknowledgement or any form of suggestion that the prior art forms part of the common general knowledge in the field of endeavor in any country in the world.

Where reference is used herein to directional terms such as ‘up’, ‘down’, ‘forward’, ‘rearward’, ‘horizontal’, ‘vertical’ etc., those terms refer to when the apparatus is in a typical in-use position and are used to show and/or describe relative directions or orientations.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The terms “approximately,” “about,” and “substantially” as used herein represent an amount close to the stated amount that still performs a desired function or achieves a desired result. For example, in some embodiments, as the context may permit, the terms “approximately”, “about”, and “substantially” may refer to an amount that is within less than or equal to 10% of, within less than or equal to 5% of, and within less than or equal to 1% of the stated amount.

The disclosed apparatus and systems may also be said broadly to consist in the parts, elements and features referred to or indicated in the specification of the application, individually or collectively, in any or all combinations of two or more of said parts, elements or features.

Depending on the embodiment, certain acts, events, or functions of any of the algorithms, methods, or processes described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially.

It should be noted that various changes and modifications to the presently preferred embodiments described herein will be apparent to those skilled in the art. Such changes and modifications may be made without departing from the spirit and scope of the disclosed apparatus and systems and without diminishing its attendant advantages. For instance, various components may be repositioned as desired. It is therefore intended that such changes and modifications be included within the scope of the disclosed apparatus and systems. Moreover, not all of the features, aspects and advantages are necessarily required to practice the disclosed apparatus and systems.

Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Unless the context clearly requires otherwise, throughout the disclosure, the words “comprise,” “comprising,” “include,” “including,” and the like are to be construed in an inclusive sense, as opposed to an exclusive or exhaustive sense; that is to say, in the sense of “including, but not limited to.” The words “coupled” or connected”, as generally used in this disclosure, refer to two or more elements that may be either directly connected, or connected by way of one or more intermediate elements. Additionally, the words “herein,” “above,” “below,” and words of similar import, when used in this application, shall refer to this application as a whole and not to any particular portions of this application.

Where the context permits, words in this disclosure using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

What is claimed is:

1. A computer-implemented method for synchronizing signals received from a plurality of sensors, the computer-implemented method comprising:
by an electronic processor configured to execute specific computer-executable instructions stored in a non-transitory memory:
receiving a first signal from a first sensor, the first signal comprising a first plurality of event signatures;
receiving a second signal from a second sensor, the second signal comprising a second plurality of event signatures;
identifying a pair of event signatures comprising a first event signature from the first plurality of event signatures and a second event signature from the second plurality of event signatures;
determining a time-shift between the first and second signals based at least in part on the identified pair of event signatures; and
adjusting the second signal based on the determined time-shift, wherein the pair of event signatures are associated with the same physical event.

2. The computer-implemented method of claim 1, wherein determining the time-shift comprises determining time stamps for individual event signatures of the pair of event signatures, generating an event vector based on a difference between the time stamps, and determining a synchronization operator using the event vector.

3. The computer-implemented method of claim 2, wherein determining the time-shift comprises a statistical analysis based on the event vector.

4. The computer-implemented method of claim 1, wherein determining the time-shift comprises:
determining a first differential shift parameter indicating a difference between zero-crossing points of the first and second signals;
determining a second differential shift parameter indicating a difference between event-starting points of the first and second event signatures; and
determining the time-shift based on the first and second differential shift parameters.

5. The computer-implemented method of claim 4, wherein determining the time-shift comprises performing a statistical analysis based on the first and second differential shift parameters.

6. The computer-implemented method of claim 5, wherein the statistical analysis comprises determining an expected value based on a plurality of differential shift parameters determined for a plurality of event pairs, wherein the plurality of event pairs are identified in a plurality of sensor signals received from the first and second sensors.

7. The computer-implemented method of claim 1, wherein identifying the pair of event signatures comprises determining a similarity condition for the first and second event signatures.

8. The computer-implemented method of claim 7, wherein determining the similarity condition comprises determining first and second differential waveforms for the first and second event signatures, respectively.

9. The computer-implemented method of claim 8, wherein determining the similarity condition further comprises determining at least two correlation coefficients based on the first and second differential waveforms and first and second time-windows, respectively, and determining the maximum values of individual ones of the at least two correlation coefficients over respective time-windows.

10. The computer-implemented method of claim 9, wherein identifying the pair of event signatures comprises identifying the pair of event signatures based at least in part on the maximum values of individual ones of the at least two correlation coefficients.

11. The computer-implemented method of claim 9, wherein determining the similarity condition further comprises determining time stamps associated with maximum values of the at least two correlation coefficients.

12. The computer-implemented method of claim 11, wherein identifying the pair of event signatures comprises identifying the pair of event signatures based at least in part on the time stamps.

13. The computer-implemented method of claim 11, wherein identifying the pair of event signatures comprises identifying the pair of event signatures based at least in part on the time stamps and the maximum values of individual ones of the at least two correlation coefficients.

14. The computer-implemented method of claim 11, wherein determining the time-shift comprises generating an event vector based at least in part on the difference between the time stamps and determining a synchronization operator using the event vector.

15. The computer-implemented method of claim 14, wherein determining the time-shift comprises a statistical analysis based on the event vector.

16. The computer-implemented method of claim 15, wherein the statistical analysis comprises determining a Median Absolute Deviation (MAD) using the event vector.

17. The computer-implemented method of any one of claims 15 and 16, wherein the event vector comprises time stamps associated with a plurality of event pairs in a plurality of sensor signals received from the first and second sensors.

18. The computer-implemented method of any one of claims above wherein the first and second signals comprise first and second waveforms and the first and second event signatures comprise portions of the respective waveforms.

19. A system for synchronizing waveforms received from a plurality of sensors, the system comprising:
a non-transitory memory storing specific computer-executable instructions; and
an electronic processor configured to execute specific computer-executable instructions stored in the non-transitory memory to:
receive a first signal from a first sensor, the first signal comprising a first plurality of event signatures;
receive a second signal from a second sensor, the second signal comprising a second plurality of event signatures;
identify a pair of event signatures comprising a first event signature from the first plurality of event signatures and a second event signature from the second plurality of event signatures;
determine a time-shift between the first and second signals based at least in part on the identified pair of event signatures; and
adjust the second signal based on the determined time-shift, wherein the pair of event signatures are associated with the same physical event.

20. The system of claim 19, wherein the electronic processor executes specific computer-executable instructions to determine the time-shift by determining time stamps for individual event signatures of the pair of event signatures, generating an event vector based on difference between the time stamps, and determining a synchronization operator using the event vector.
